(19) United States
(12) Patent Application Publication
(10) Pub. No.: US 2004/0189982 A1
(43) Pub. Date: Sep. 30, 2004

(54) Optical sensor for volatile organic compounds

(75) Inventors: Pierre Galarneau, Cap-Rouge (CA); Marc Levesque, St-Augustin-de-Desmaures (CA)

Correspondence Address: MERCHANT & GOULD PC, P.O. BOX 2903, MINNEAPOLIS, MN, 55402-0903, US

(73) Assignee: Institut National D'Optique, Sainte-Foy, QC (CA)

(21) Appl. No.: 10/397,102

(22) Filed: Mar. 26, 2003

(51) Int. Cl. G01N 21/41

(52) U.S. Cl. 356/128; 356/135

(57) ABSTRACT

An optical sensor for volatile organic compounds includes a light transmission medium and a porous medium, having an interface therebetween. A light source directs a beam of light into the light transmission medium at an incidence angle with respect to the interface. A detector is provided for measuring an intensity of light reflected by the interface or transmitted by the porous medium. The light transmission medium and the porous medium have different mediums of refraction to create a total internal reflection condition. The condition is gradually deteriorated as the porous medium is exposed to volatile organic compounds, since the adsorption of the compounds modifying the index of refraction of the porous medium.

### FIELD OF THE INVENTION

The present invention is directed to an optical sensor for volatile organic compounds, and more particularly to such a sensor which can be integrated into a respirator cartridge.

### DESCRIPTION OF THE PRIOR ART

Respirator cartridges, and devices which incorporate them, are among the most important security devices used to protect the health of workers. More than 10 million respirator cartridges are used each day in North America.

One of the critical elements related to efficient and safe use of these cartridges is their life span. In the case of gas and vapor pollutants, often the only indicator of the saturation of the cartridge is the odor of the pollutant. This is a dangerous indicator of the end of service of the cartridge since there are many pollutants whose olfactory detection level is below the Threshold Limit Value (TLV). For a user, it is desirable that the cartridge includes an active indicator to indicate without ambiguity that the useful life of the cartridge has ended. In 1984, the National Institute for Occupational Safety and Health (NIOSH) published standards for the certification of active end-of-life indicators to encourage the development of such systems.

One type of active end-of-life indicator presently under investigation is based on the use of polymer films containing carbon particles. The presence of soluble organic vapours causes a change in the resistance of the film and it is this element that is measured. Another type of indicator is described in U.S. Pat. No. 4,146,887 to Magnante, describing the use of a temperature sensor (thermocouple or other) to detect the exothermic reaction of gas/vapour absorption in a respirator cartridge.

A related field to the invention is the field of fiber optic chemical sensor (FOCS). Many articles have been published and several patents awarded for the use of FOCS to detect solvent or chemical products. The vast majority of FOCS use a spectroscopic approach in one form or another, i.e. they rely on light absorption at specific wavelengths to identify chemical species.

Some FOCS measure light loss caused by refractive index change. For instance, U.S. Pat. No. 5,828,798 (HOPENFELD JORAM) describes the use of a specially shaped plastic fiber with a coating that dissolves in the presence of the analyte to be detected. The HOPENFELD patent claims a fiber optic sensor different from other fiber optic sensors in that the cladding material has a refractive index superior to the refractive index of the core, and that the fiber has a specific shape to increase its sensitivity. Furthermore, in the HOPENFELD patent, the cladding is chosen to be specific to a particular analyte and will dissolve in the presence of the analyte. As a result, the light transmitted by the fiber increases in the presence of the analyte.

Few FOCS use porous material, although an article published in Electronic Letters, vol. 24, p. 42 (1988) describes the use of an optical fibre having a porous cladding to measure humidity levels. In this case, the optical fibre is manufactured by depositing porous glass soot on a pure silica fibre. The intensity of the transmitted light decreases by 60% when the relative humidity reaches 90%. In this case, the fibre is straight.

U.S. Pat. No. 5,250,095 (SIGEL J. R. GEORGE ET AL) describes the use of a porous fiber as a chemical sensor. In this case, the pores are used as an optical chamber to contain the agent which will cause a change in the optical transmission of light by the agent and not because of changes to the guiding properties of the fiber. The SIGEL patent is very similar to standard spectroscopy techniques to detect and identify substances: it uses a tunable narrow-wavelength light source (lamp+monochromator), an optical cell (the porous fiber) and a detector to measure the change in absorption of light as a function of wavelength. The agent(s) of interest for sensing are optically detected.

U.S. Pat. No. 6,375,725 (BERNARD et al.), assigned to the assignee of the present application, teaches an end-of-service indicator for use with a respirator cartridge, the end-of-service indicator having an optical waveguide having two extremities, one of the extremities being connected to a light source, the other of the extremities being connected to a detector which measures the intensity of light guided and transmitted by the fibre. An alarm is connected to the detector and is triggered when the intensity of light measured by the detector is below a predetermined level. An important aspect of the end-of-service indicator is that at least a portion of the optical fibre is porous. In use, the end-of-service indicator is placed inside a respirator cartridge having a gas/vapour sorbent, so that when the respirator cartridge is used in a toxic environment, the gas/vapour sorbent and the porous glass gradually become saturated. This porous glass will absorb the gas/vapour in the same fashion as the sorbent used in the respirator cartridge, thereby lowering the guiding and transmission properties of the optical fibre which loses the necessary conditions to guide light. This sensor has some disadvantages, however, in that the responses of the end-of-service indicator are strongly dependent on the index of refraction of the solvents detected, so that the indicator is very sensitive to some solvents, and less sensitive to others. Furthermore, the physical mechanisms which affect the guiding properties of porous optical fibres are not well known, which renders difficult the task of developing a compensation method.

### SUMMARY OF THE INVENTION

It is an object of the present invention to provide an optical sensor for volatile organic compounds, comprising:

a light transmission medium having a predetermined shape and at least one surface which reflects incident rays;

a porous medium having a predetermined shape and at least one surface mating with said surface of said light transmission medium;

a light source for directing a light beam into said light transmission medium at an incidence angle with respect to said surface;

means for measuring an intensity of light reflected by said surface or transmitted by said porous medium;

wherein said light transmission medium and said porous medium have indexes of refraction that are different, and wherein when said porous medium is exposed to a environment containing volatile organic compounds, said index of refraction of said porous medium changes due to adsorption, so that a total internal reflection condition is not respected when said index of refraction of said porous medium changes.

### BRIEF DESCRIPTION OF THE DRAWINGS

The present invention and its advantages will be more easily understood after reading the following non-restrictive description of preferred embodiments thereof, made with reference to the following drawings, where:

FIG. 1 is a schematic representation of a sensor for volatile organic compounds according to a first preferred embodiment of the invention;

FIG. 2 is a schematic representation of a sensor according to a second preferred embodiment;

FIGS. 3a and 3b are schematic representation of the underlying principle of operation of the sensor of the present invention;

FIG. 4 is a schematic representation of a sensor according to a third preferred embodiment of the invention; and

FIG. 5 is a schematic representation of yet another preferred embodiment of the invention.

### DESCRIPTION OF A PREFERRED EMBODIMENT OF THE INVENTION

The present invention is directed to an optical sensor for volatile organic compounds.

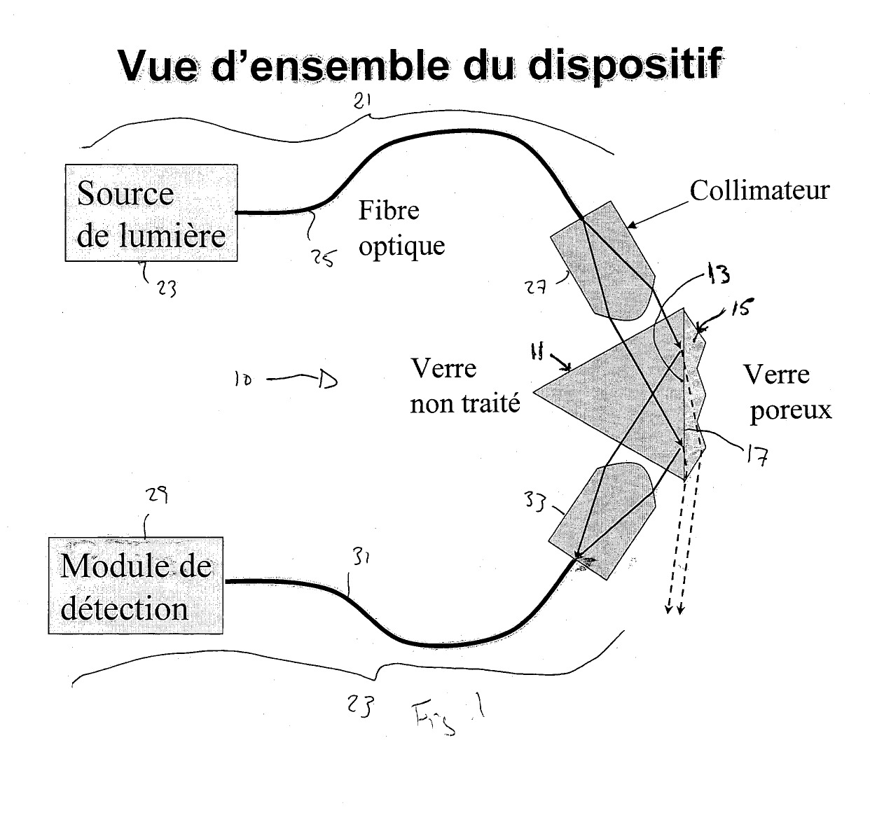

Referring now to FIG. 1, the sensor 10 comprises a light transmission medium 11, which is preferably glass, and has a polygonal shape and more preferably for the embodiment of FIG. 1, a triangular shape. The light transmission medium 11 has at least one surface 13 for reflecting incident rays. The sensor 10 also includes a porous medium 15, also having a surface 17, in contact with said surface 13, creating an interface between the light transmission medium 11 and the porous medium 13.

The porous medium 13 also preferably has a surface opposite said surface 17 which is patterned, as shown in the Figures, in order to prevent total internal reflection in that region.

In a preferred embodiment shown in FIGS. 1-9, the surfaces 13 and 17 are flat.

The sensor has a light source 21 for injecting a beam of light into the light transmission medium and means for detecting an intensity of light reflected by said flat surface 13 or transmitted by the porous medium 15.

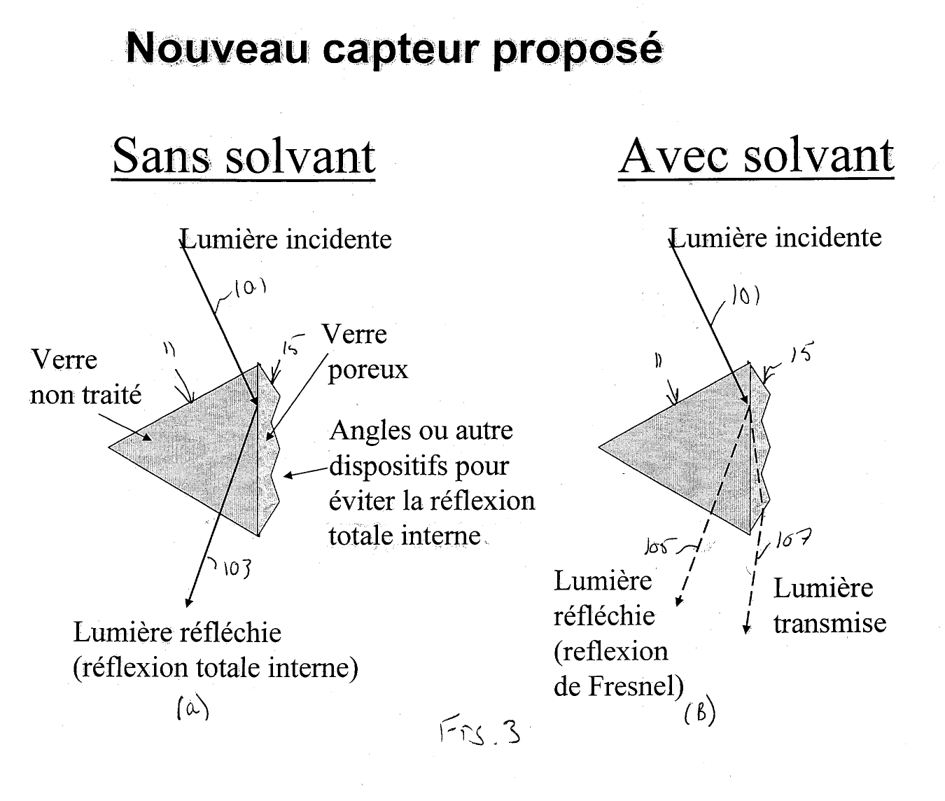

The principle underlying the present invention is shown in FIG. 3a and 3b. The light transmission medium 11 and the porous medium 15 have indexes of refraction which are different. Consequently, when light is inserted into the light transmission medium 11 at a predetermined incidence angle, determined by the relative difference in indexes of refraction, a condition of total internal reflection is observed (see FIG. 3a). In FIG. 3a, the incident light beam 101 is completely reflected at the junction between the light transmission medium 11 and the porous medium 15.

However, if the sensor is placed in an environment containing volatile organic compounds, the index of refraction of the porous medium 15 will gradually change, thereby affecting the condition of total internal reflection. Consequently, not all of the light will be reflected, some of the light actually being transmitted by the porous medium 15.

Thus, by selecting the angle at which the incident light impinges on said surface 13 so that it is very close to the critical angle for total internal reflection, a small change in the index of refraction of the porous medium 15 will not affect the total internal reflection condition. However, as the index of reflection changes over a greater range, the mismatch between the indexes of refraction results in the total internal reflection condition not being respected. This is illustrated in FIG. 3b in dotted lines, where part of the incident light 101 is reflected 105, and part is transmitted 107.

Such a gradual change can be used to measure, for instance, the degree of use of a respirator cartridge by using the sensor of the present invention as an end-of-service indicator.

The sensor of the present invention has an advantage over that of Bernard et al. referred to above, in that it allows a direct measurement of the amount of reflected light. The device of Bernard et al. does not measure reflection, but rather a decrease in the strength of the guided signal, based on the assumption that this decrease was a result of only the change of index of refraction of the cladding of the optical fiber, which is not experimentally the case.

In a first preferred embodiment of the invention, the light source 21 includes a laser 23, an optical fiber 25 connected to the laser at one end and connected to a collimator 27 at the other end to collimate light into the light transmission medium 11. On the other side of the device 10, a collimator 33 collects light reflected by the flat surface 13, and directs it into a fiber 31 which is connected to a detector 29. Collimator 33, fiber 31 and detector 29 form, in this embodiment, the means 23 for measuring an intensity of light reflected.

Alternatively, it will be appreciated that the means 23 can be operatively connected to the porous medium 15 to measure an intensity of light transmitted.

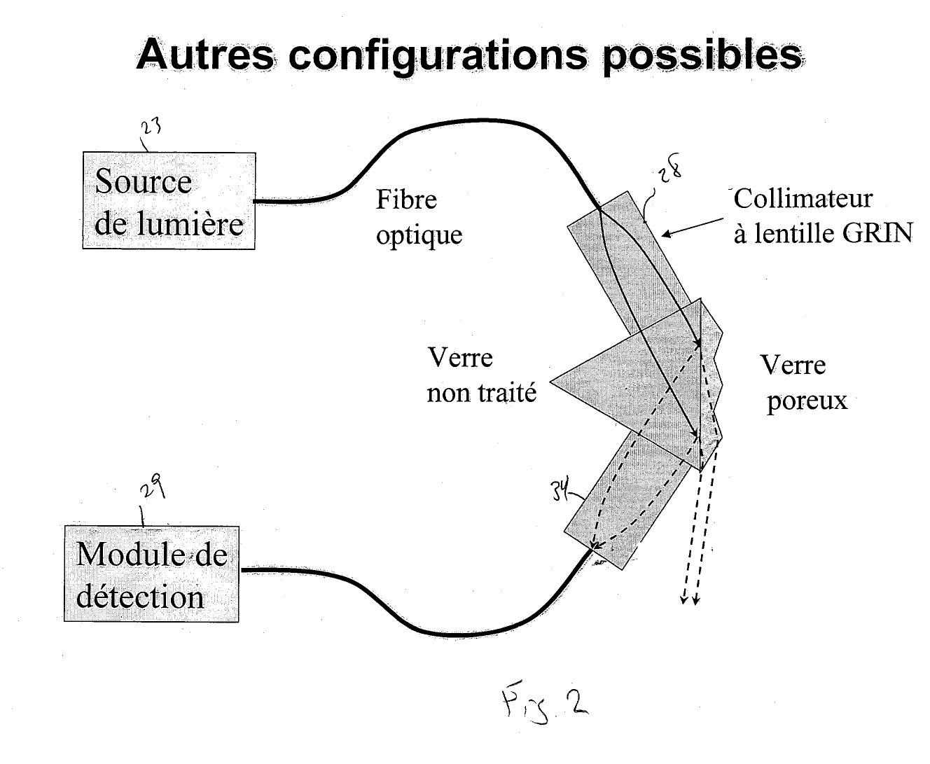

In a second preferred embodiment, shown in FIG. 2, the collimators 27 and 33 are replaced by Grin lenses 28, 34, all other elements being the same between FIG. 1 and FIG. 2.

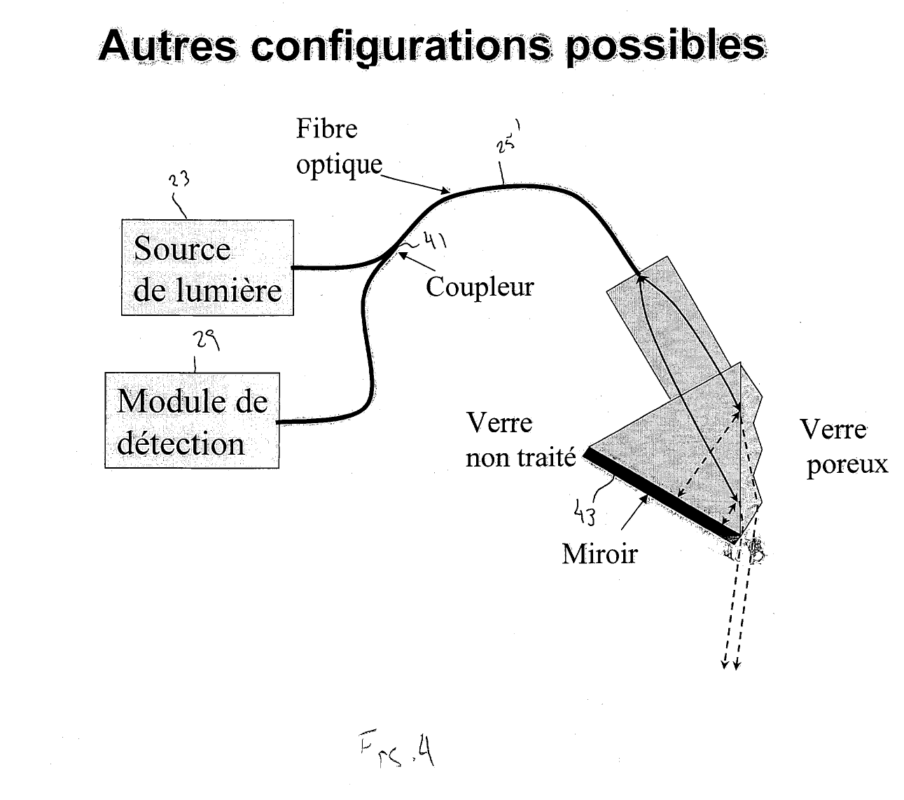

In a third preferred embodiment shown in FIG. 4, the light source 21 and the means 23 are on the same side of the device 10, and share, for inserting and extracting light the same optical fiber 25′. However, fiber 25′ is further provided with a coupler 41 for allowing light emitted by said light source to be inserted into said sensor 10 and for allowing light reflected by the surface 13, and then reflected back along its path by mirror 43 to reach the detector 29.

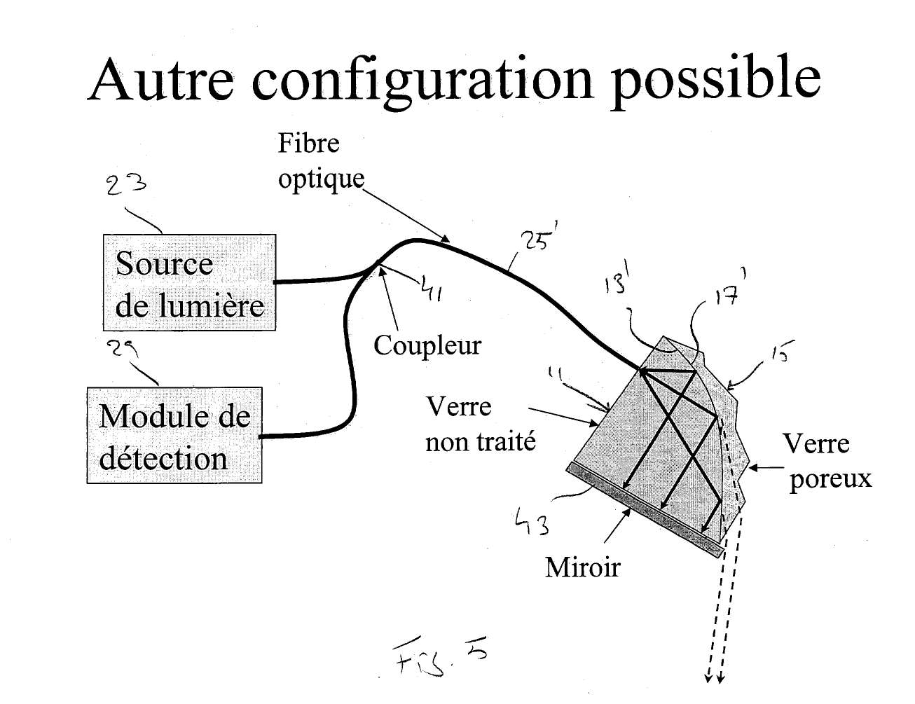

In yet another embodiment, shown in FIG. 5, where like parts as in FIG. 4 bear the same reference number, the surface 13 is not flat but rather concave. This configuration also clearly illustrates that light transmission medium 11 does not guide the light, but rather lets it travel freely.

It should also be apparent to persons skilled in the art that a variety of different configurations for inserting light into the light transmission medium 11 and collecting the light reflected at the flat surface 11 or transmitted by the porous medium 15 are all within the scope of the appended claims. Furthermore, selection of materials, calculation of the incident angle, etc., are all also within the skill of a person having experience in this field.

Although the present invention has been explained hereinabove by way of a preferred embodiment thereof, it should be pointed out that any modifications to this preferred embodiment within the scope of the appended claims is not deemed to alter or change the nature and scope of the present invention.

What is claimed is:

1. An optical sensor for volatile organic compounds, comprising:
a light transmission medium having a predetermined shape and at least one surface which reflects incident rays;
a porous medium having a predetermined shape and at least one surface mating with said surface of said light transmission medium;
a light source for directing a light beam into said light transmission medium at an incidence angle with respect to said surface;
means for measuring an intensity of light reflected by said surface or transmitted by said porous medium;
wherein said light transmission medium and said porous medium have indexes of refraction that are different, and wherein when said porous medium is exposed to a environment containing volatile organic compounds, said index of refraction of said porous medium changes due to adsorption, so that a total internal reflection condition is not respected when said index of refraction of said porous medium changes.

2. An optical sensor for volatile organic compounds according to claim l, wherein said means for measuring an intensity of light measure light reflected by said surface.

3. An optical sensor for volatile organic compounds according to claim 2, wherein said sensor has two opposite ends, said light source being located at one opposite end, and said means for measuring an intensity of light being located at said other opposite end.

4. An optical sensor for volatile organic compounds according to claim 2, wherein said light source includes a laser, an optical fiber and a collimator for collimating light into said light transmission medium, and said means for measuring an intensity of light include a detector, an optical fiber and a collimator for collimating light out of said light transmission medium.

5. An optical sensor for volatile organic compounds according to claim 2, wherein said light transmission medium includes a mirror for reflecting light reflected by said surface back along an input path, and wherein said light source includes a laser, a coupler and a lens for inserting light into said light transmission medium and out of said light transmission medium, and wherein said means for measuring an intensity of light include an optical fiber connected to said coupler and a detector.

6. An optical sensor for volatile organic compounds according to claim 2, wherein said light source includes a laser, an optical fiber and a lens for inserting light into said light transmission medium, and said means for measuring an intensity of light include a detector, an optical fiber and a lens for extracting light out of said light transmission medium.

7. An optical sensor for volatile organic compounds according to claim 1, wherein said porous medium has a surface opposite said surface of said porous medium which is patterned.

8. An optical sensor for volatile organic compounds according to claim 1, wherein said surface which reflects incident rays of said light transmission medium is flat.

9. An optical sensor for volatile organic compounds according to claim 1, wherein said surface which reflects incident rays of said light transmission medium is concave.

10. An optical sensor for volatile organic compounds according to claim 1, wherein said incidence angle is close to an angle for total internal reflection.
